(19) United States
(12) Patent Application Publication
(10) Pub. No.: US 2019/0337281 A1
(43) Pub. Date: Nov. 7, 2019

(54) APPARATUS FOR HANDLING AND LOCALLY FIXING FLAT THERMOPLASTIC MATERIALS

(71) Applicant: ENGEL AUSTRIA GmbH, Schwertberg (AT)

(72) Inventors: Norbert MUELLER, Passau (DE); Philipp SEINSCHE, Linz (AT)

(21) Appl. No.: 16/403,791

(22) Filed: May 6, 2019

(30) Foreign Application Priority Data
May 7, 2018 (AT) A 50380/2018

(51) Int. Cl. B32B 38/18; B25J 15/06; B25J 15/00; B32B 41/00; B32B 37/06

(52) U.S. Cl. CPC B32B 38/1858; B25J 15/0616; B32B 37/06; B32B 41/00; B25J 15/0085

(57) ABSTRACT

An apparatus for handling and locally fixing flat thermoplastic materials includes at least one holding device to be applied with a holding region for exerting a holding force against a surface of the flat thermoplastic material. Arranged within or surrounded by the holding region of the at least one holding device is at least one heating element by which the flat thermoplastic material can be locally thermally fixed to a join partner within or surrounded by the holding region of the at least one holding device.

### BACKGROUND OF THE INVENTION

The present invention concerns an apparatus for handling and locally fixing flat thermoplastic materials, an arrangement of at least two apparatuses for handling and locally fixing flat thermoplastic materials, and a handling device for receiving, transporting and/or depositing at least one flat thermoplastic material.

To be able to make optimum use of the lightweight construction potential of fiber composite materials a load-optimized and waste-optimized arrangement of the reinforcing fibers in the component is indispensable. Additive manufacture—that is to say the successive “deposit” of material to provide a defined three-dimensional body—has proven to be a processing procedure which is highly suited to the material involved, precisely in the field of fiber composite materials. The “deposit” of material, especially flat thermoplastic materials, can be implemented for example by the so-called pick-and-place method. In that method, flat thermoplastic materials, preferably with a fiber reinforcement, particularly preferably with a unidirectional fiber reinforcement, are received by handling devices from a storage means or magazine, transported to a previously defined deposit position, and deposited there. Such a handling device comprises a motion unit like for example an articulated arm robot and an end effector, which, depending on the flat thermoplastic materials to be handled, can be equipped with clamping, needle, suction grippers or the like. Suction grippers, also referred to as vacuum handling devices, are described for example by DE 20 2013 009294 U1 or DE 10 2009 047916 B4. In that case, depending on the requirements involved, different operative principles are used for generating the vacuum (Coanda, venturi or Bernoulli principle). Such gripping systems have become increasingly adopted for handling thin flat materials as they hold the flat thermoplastic material securely in position without it being damaged in that case—as occurs in the case of needle grippers.

Further suction grippers known from the state of the art are disclosed in DE 4127133 A1, EP 0 397 029 A2, DE 20 2012 101 859 U1 and in DE 2 535 460 A1, wherein these devices are provided with temperature control units in order to adjust the gripper to a temperature of the material to be gripped. From WO 2010/073514 A1 an electrostatic gripper comprising such a temperature control unit is known. This temperature control of the gripper is to avoid damages to the material to be gripped due to thermal stress or to the formation of condensate between the gripper and the material to be gripped.

After the flat thermoplastic material to be processed has been placed at its predetermined location by the handling device it has to be secured against slipping in some fashion for further processing. In the case of thermoplastic materials, that is generally achieved by means of a material-bonded connection between the substrate which has already been deposited—also referred to hereinafter as the join partner—and the flat thermoplastic material deposited thereon. The fusibility of the flat thermoplastic material is utilized for making the connection. The energy necessary for that purpose can be supplied by a heating element, for example with a resistance heating means or by an ultrasonic sonotrode. The two components (flat thermoplastic material and join partner) are pressed against each other and welded together.

The thermal contact or the thermal pulse welding method is in the packaging industry a well-established method of welding thin films with a fast cycle time. As film-like semi-finished articles (flat thermoplastic materials) are also processed using the pick-and-place method those welding methods are suitable for making a material-bonded connection between the join partner and the thermoplastic material. For that purpose use is generally made of electrically heatable heating elements which exert a pressure immediately after positioning of the semi-finished article on the flat thermoplastic material and connect the flat thermoplastic material to the join partner by the supply of heat.

Another known configuration in the state of the art provides that a heating element is mounted to the holding device which can be applied with a holding region for exerting a holding force against a surface of the flat thermoplastic material, the heating element being thus mounted separately from that holding unit, wherein a welding operation can be carried out after positioning by the heating element. For mounting the two components on the end effector however it is necessary for same to be adapted to the geometry of the flat thermoplastic material to be handled. That however results in an increased requirement for adaptation upon any change in the geometry of the flat thermoplastic material as a fresh position has to be selected both for the holding element and also for the heating element. In addition a specific fixing is to be provided on the end effector both for the holding element and also for the heating element, and that is disadvantageous in regard to saving weight and the agility involved therewith of the entire system.

Thus an increased amount of structural space is necessary for the arrangement of the holding element and the heating element. That limits on the one hand the maximum number of holding elements and/or heating elements which can be disposed on an end effector, while on the other hand it increases the minimum handleable size for the flat thermoplastic materials.

In addition the deposit accuracy which can be achieved in respect of a flat thermoplastic material suffers by virtue of the above-mentioned arrangement of the two elements. In the case of larger spacings between the holding and the heating elements, there is an increased probability that the fixing position of the flat thermoplastic material differs from the target position by virtue of the non-existent guidance. As a result gases or also overlaps can occur, which represent a weak point in the subsequent component.

By virtue of the fact that, in the state of the art, the heating element comes into contact only immediately after attainment of the final position of the flat thermoplastic material in order to weld same, very high heating temperatures are necessary for short welding times so that the flat thermoplastic material to be deposited can be rapidly completely fused over its entire thickness and thus welding to the join partner can be achieved.

The object of the invention is to provide an apparatus for handling and locally fixing flat thermoplastic materials, an arrangement of at least two apparatuses for handling and locally fixing flat thermoplastic materials, and a handling device, in which an improvement is at least partially achieved over the above-mentioned disadvantages in the state of the art.

### SUMMARY OF THE INVENTION

The above object is attained by an apparatus in which, arranged within or surrounded by a holding region of at least one holding device, is at least one heating element by which the flat thermoplastic material can be locally thermally fixed to a join partner within or surrounded by the holding region of the at least one holding device.

Thus, in a variant by way of example, the heating element can be integrated into the holding device, more precisely into the holding region. Introduction of the necessary heating energy can be effected electrically or inductively. A structure having a heating means using hot gas is also certainly conceivable. Structures with an ultrasonic sonotrode are equally conceivable.

According to the invention, it is therefore provided that the at least one heating element is arranged within a holding region or surrounded by a holding region. In other words, the heating element is integrated into the holding element and thus the function of handling and local thermal fixing can be combined in one installation component by virtue of the apparatus according to the invention.

This therefore provides a compact apparatus for handling and thermal fixing, which requires a small amount of space and is of a low weight in comparison with the above-mentioned configurations in the state of the art. Accordingly the weight and thus the inertia of the overall handling system is reduced, which in turn contributes to enhancing flexibility and agility.

In addition, the apparatus according to the invention makes it possible to handle substantially smaller flat thermoplastic materials in comparison with the structures known in the state of the art. As the heating element is now arranged within or surrounded by the holding region the minimum size of a flat thermoplastic material is only still limited to the size of the holding region.

A further substantial advantage of the apparatus according to the invention is that it ensures a high level of deposit accuracy. By virtue of the integration of the heating element into the holding region, the flat thermoplastic material is thermally fixed precisely where it is held by the holding region. It is possible in that way to effectively counteract displacement of the flat thermoplastic material by virtue of the welding operation and formation linked thereto of gases or overlaps of the flat thermoplastic material.

Preferably, the flat thermoplastic material can be locally thermally fixed to the join partner in a state held by the at least one holding device. In this connection, it can be provided that the flat thermoplastic material is held by a holding force to the holding device while the flat thermoplastic material can be locally thermally fixed to the join partner without an additional pressure force occurring between the flat thermoplastic material and the join partner.

However, the flat thermoplastic material, in a state of being held by the at least one holding device, can be already locally heated before being placed on the join partner. In that case, heating at the holding device can already begin upon being received, immediately after being received, or at any point in time during transport to the join partner. The flat thermoplastic material can be heated upon reaching the join partner but still in the solid-body state, or selectively also when already in the melted state. The possibility of bringing forward the commencement of heating in that way means that the heating element can be operated at a lower temperature. That has a positive effect on the longevity of the apparatus and results in a lower level of thermal loading on the flat thermoplastic material.

Furthermore, the at least one heating element can connected to the at least one holding device moveably—preferably by a spring element. Thus, for example, a heating element can be so mounted to the holding device that, during a handling operation, the heating element remains in a retracted state and it is only when local thermal fixing of the flat thermoplastic material is required by the heating element that the heating element is moved to the thermoplastic material. That configuration makes it possible to leave the heating element in a heated state and to alter the thermal energy which is transmitted to the flat thermoplastic material only by a displacement of the heating element. Thus it can preferably be provided that the flat thermoplastic material is heatable continuously or in interval mode by the at least one heating element.

Particularly preferably, an insulating layer can be provided at least region-wise between the at least one heating element and the at least one holding device. The holding device can be protected from thermal energy from the at least one heating element by that insulating layer, and possible damage to the holding device by that thermal energy can be avoided.

In a further embodiment, the at least one holding device can be in the form of an electrostatic gripper, and an electrostatic charge of a contact surface of the electrostatic gripper can be applied or changed by at least one activation device.

Alternatively, however, the at least one holding device can be in the form of a vacuum suction gripper. Furthermore, the at least one heating element can be arranged in a suction region of the vacuum suction gripper and/or the vacuum suction gripper has a suction device, wherein a reduced pressure can be produced in a suction region of the vacuum suction gripper by the suction device. That suction device can be implemented for example on the basis of the Coanda, venturi or Bernoulli principle.

Furthermore, an arrangement can include at least two apparatuses according to the invention for handling and locally fixing flat thermoplastic materials, with the at least two apparatuses being connected together by a carrier structure. Such a carrier structure in that respect can have a one-part or multi-part configuration. Preferably, the at least two apparatuses are arranged so that at least one flat thermoplastic material can be held at one side in unilateral contacting relationship along a surface by the at least two holding devices.

Particularly preferably, an open-loop or closed-loop control unit is provide, wherein each apparatus (or when there are more than two apparatuses a group of apparatuses) can be selectively open-loop or closed-loop controlled by the open-loop or closed-loop control unit. At least one holding device can be selectively open-loop or closed-loop controlled and/or at least one heating element can be selectively open-loop or closed-loop controlled by the open-loop or closed-loop control unit. Accordingly, a group or a single apparatus can be actuated individually, more precisely the heating element or the holding function of the individual apparatus or apparatuses. Such a configuration makes it possible, in the case of an arrangement of a plurality of apparatuses, to actuate only the apparatuses which are required for handling or thermal fixing of a certain flat thermoplastic material. Accordingly there is a high degree of flexibility in respect of the external contour of a flat thermoplastic material, in respect of the handling or local fixing of which only the apparatuses which are required are used while the remaining apparatuses of the arrangement are put into a non-active operating state.

In addition protection is claimed for a handling device for picking up, transporting or depositing at least one flat thermoplastic material comprising at least one apparatus according to the invention and/or an arrangement according to the invention.

### BRIEF DESCRIPTION OF THE DRAWINGS

Further details and advantages of the present invention are described more fully hereinafter by means of the specific description with reference to the embodiments by way of example illustrated in the Figures in which:

FIG. 1a shows a first variant of an apparatus according to the invention,

FIG. 1b shows an isometric view of FIG. 1a,

FIG. 2 shows a second variant of an apparatus according to the invention,

FIG. 3 shows a third variant of an apparatus according to the invention,

FIG. 4 shows a fourth variant of an apparatus according to the invention,

FIG. 5 shows a fifth variant of an apparatus according to the invention,

FIG. 6a shows a sixth embodiment of an apparatus according to the invention,

FIG. 6b shows an isometric view of FIG. 6a,

FIG. 7 shows an arrangement according to the invention by way of example,

FIG. 8 shows an arrangement according to the invention by way of example,

FIGS. 9a and 9b shows an arrangement according to the invention by way of example,

FIG. 10 shows a handling device,

FIG. 11 shows contacting of an apparatus according to the invention with a flat thermoplastic material,

FIG. 12 shows holding of a flat thermoplastic material by means of an apparatus according to the invention,

FIG. 13 shows removal of a flat thermoplastic material from a magazine,

FIG. 14 shows contacting between a join partner and a flat thermoplastic material,

FIG. 15 shows the application of thermal energy to the flat thermoplastic material,

FIG. 16 shows detachment of the apparatus according to the invention from a flat thermoplastic material,

FIG. 17 shows contacting of a flat thermoplastic material with its join partner in the magazine,

FIG. 18 shows local fixing of a flat thermoplastic material to its join partner, and

FIG. 19 shows removal of a flat thermoplastic material together with its join partner from the magazine.

### DETAILED DESCRIPTION OF THE INVENTION

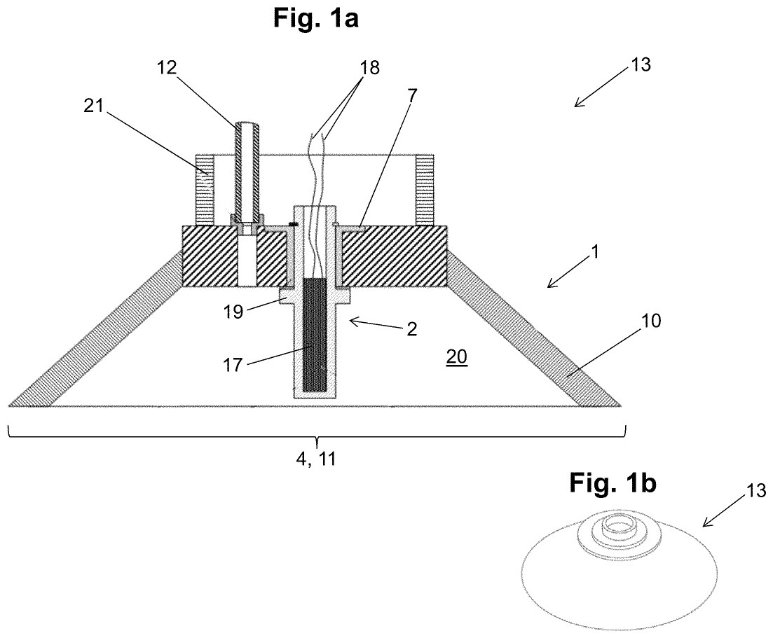

FIG. 1a shows a first embodiment of an apparatus 13 according to the invention for handling and locally fixing flat thermoplastic materials 3. In this case the apparatus has a handling device 1 which is in the form of a vacuum suction gripper 10, and a heating element 2. In this arrangement the heating element 2 is disposed in a central region of the vacuum suction gripper 10. The heating element 2 itself is in the form of a heating cartridge which can be supplied with power by way of power cables 18. That heating cartridge 17 is mounted within a receiving sleeve 19 connected to the holding device 1 by way of an insulating layer 7. The holding device 1 forms an internal space 20 which can be subjected to vacuum by means of a suction device 12 in order to hold a flat thermoplastic material 3 in a suction region 11 or also a holding region 4.

FIG. 1b shows an isometric view of the apparatus 13 of FIG. 1a.

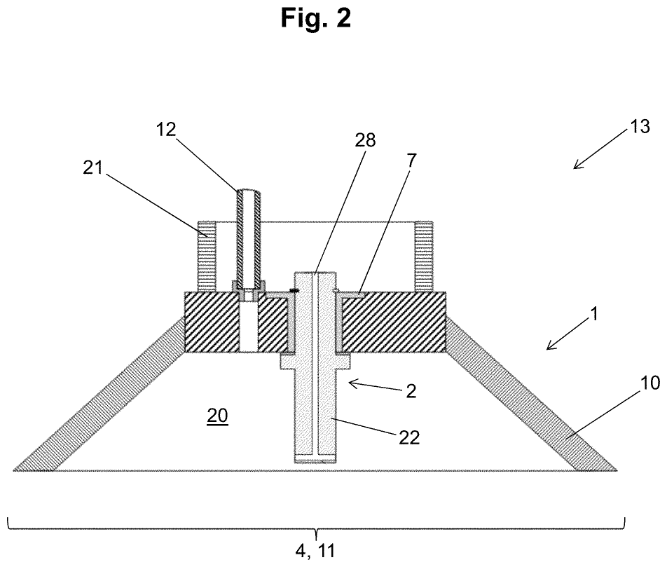

FIG. 2 shows a second variant of an apparatus 13 according to the invention for handling and local fixing of flat thermoplastic materials 3. Here too once again the holding device 1 is in the form of a vacuum suction gripper 10. The vacuum suction gripper 10 can again be caused to produce a vacuum in its internal space 20 by the suction device 12 in order to hold a flat thermoplastic material 3 in the suction region 11 or the holding region 4. In this embodiment however the heating elements 2 is in the form of a hot gas nozzle 22. The hot gas nozzle 22 is in turn arranged in a central region of the holding device 1 and connected by way of an insulating layer 7 to the holding device 1, more precisely to the vacuum suction gripper 10. In such a configuration hot gas can be passed by means of the hot gas nozzle 22, more precisely by way of the feed passage 28, in which case that hot gas heats the heating element 2 disposed in the suction region 11, more precisely centrally in the holding region 4. As already provided in FIG. 1a there is a mounting device 21 in order to mount the apparatus 13 to a handling device 6 or a carrier structure 14.

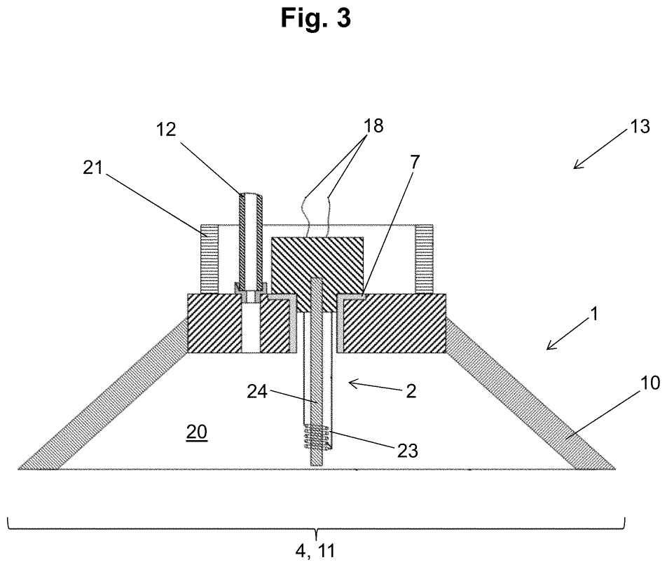

FIG. 3 shows a third embodiment of an apparatus 13 according to the invention. As already described in relation to the preceding Figures in this embodiment also the holding device 1 is in the form of a vacuum suction gripper 10, wherein a vacuum can be produced in an internal space 20 of the vacuum suction gripper 10 by way of a suction device 12. In this embodiment the heating device 2 is in the form of an induction coil 23 which can heat a heating rod 24 by means of electrical energy supplied to the induction coil 23 by way of the power cables 18. That heating element 2 is in turn connected to the holding device 1 by means of an insulating layer 7. Once again subsequently a flat thermoplastic material 3 arranged in the holding region 4 of the vacuum suction gripper 10 can be locally heated by the heating element 2 in order to locally thermally fix that flat thermoplastic material 3 to a join partner 5.

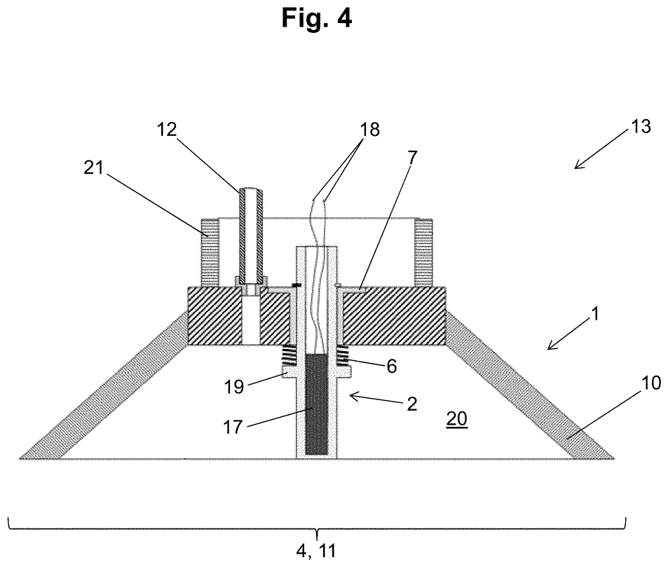

FIG. 4 shows a further embodiment of an apparatus 13 according to the invention. Once again (similarly as in FIG. 1a) the apparatus 13 is provided by a vacuum suction gripper 10 which functions as a holding device 1 and in the internal space 20 of which a vacuum can be produced by the suction device 12 in order to hold a flat thermoplastic material 3 in a holding region 4, more precisely in a suction region 11 of the apparatus 13. The heating element 2 is again formed by a heating cartridge 17 arranged in a receiving sleeve 19, wherein the receiving sleeve 19 is connected to the holding device 1 by way of an insulating layer 7. The heating cartridge 17 is again supplied with electrical energy by way of power cables 18. In this embodiment however the heating element 2 is connected moveably to the holding device 1, more precisely the heating element 2—the receiving sleeve 19—is connected to the holding device 1 by way of the spring elements 6 and can thus perform a movement in its axial direction. That configuration with the spring element 6 is intended subsequently to ensure that, when a flat thermoplastic material 3 is sucked in position in the suction region 11 by the vacuum suction gripper 10, that flat thermoplastic material 3 is not plastically deformed or damaged by the heating element 2 as the flexible sealing lips of the vacuum suction gripper 10 can generally be easily elastically deformed and it would thus be possible that, if the heating element 2 were not axially moveable, it would penetrate or deform the flat thermoplastic material 3 to be taken up.

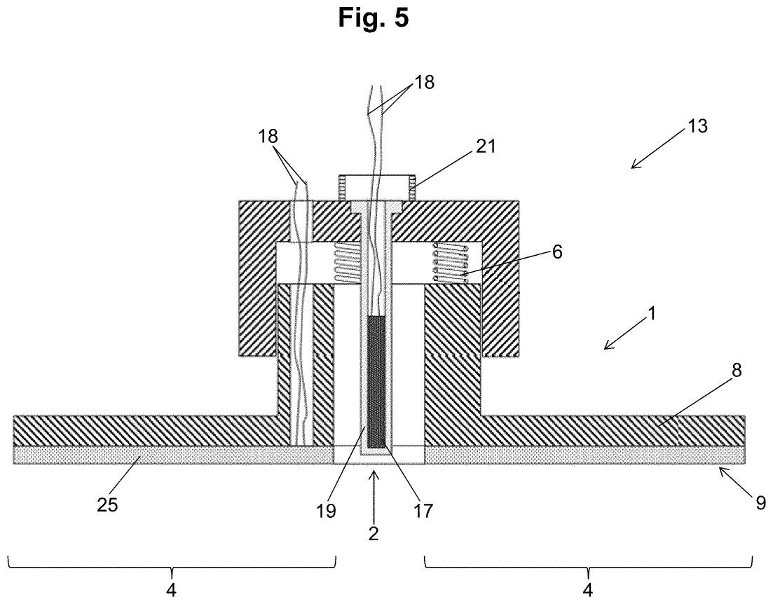

FIG. 5 shows a fifth embodiment of an apparatus 13 according to the invention, in which the holding device 1 is in the form of a so-called electrostatic gripper 8. That electrostatic gripper 8 has an electrostatic film 25, wherein the film 25 can change an electrical charge at its contact surface 9 by means of an activation device (not shown). That activation device can be connected to the electrostatic film by way of the power cables 18. The electrostatic gripper 8 can hold a flat thermoplastic material 3 which is in contact with the contact surface 9 in the holding regions 4 by virtue of the change in the electrical charge at the contact surface 9. In this embodiment the heating element 2 is again formed by a heating cartridge 17 fixed to the holding device 1 by means of a receiving sleeve 19. The heating cartridge 17 can again be supplied with electrical energy by the power cables 18. In that respect it can be clearly seen from FIG. 5 how the heating element 2 is surrounded by the holding regions 4. The apparatus 13 again has a mounting arrangement 21.

In addition in the FIG. 5 embodiment the holding device 1 is of a two-part structure, the two parts being connected together by means of spring elements 6. In that way a spacing between the heating element 2 and the flat thermoplastic material 3 which bears against the contact surface 9 can be respectively varied in accordance with the application of pressure by way of the mounting arrangement 21. It is thus certainly conceivable that the heating element 2 can be not only heated in an interval mode (in which case the heating element 2 is heated only when a thermal action on the flat thermoplastic material 3 is required), but it can also be heated throughout, that is to say continuously. Thus, depending on whether a thermal action on the flat thermoplastic material 3 is required at the current time, the spacing between the heating element 2 and the flat thermoplastic material 3 can be changed.

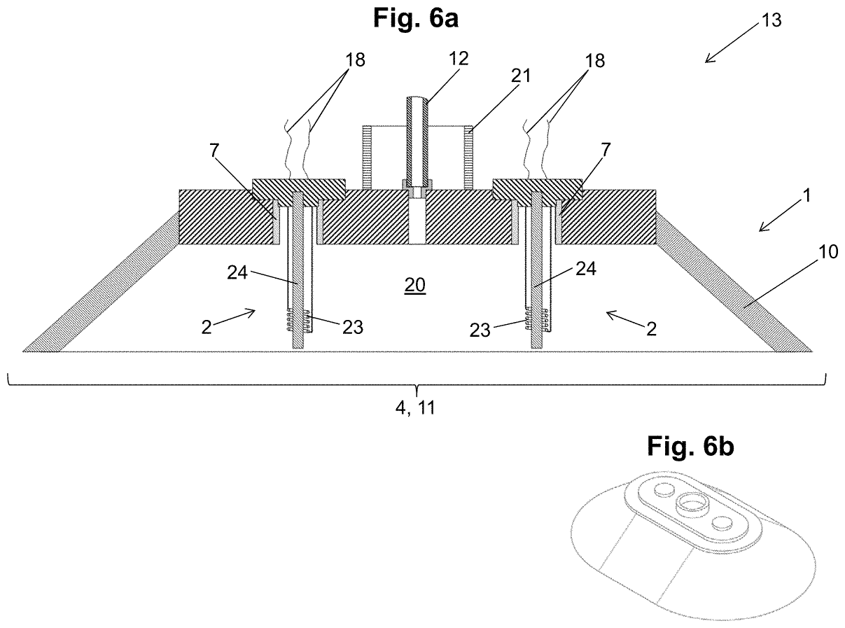

FIG. 6a shows a further variant of an apparatus 13 according to the invention, wherein once again the holding device 1 is in the form of a vacuum suction gripper 10, the internal space 20 of which can be subjected to vacuum by a suction device 12, whereby a flat thermoplastic material 3 arranged in the holding region 4 or also the suction region 11 can be held to the holding device 1. The apparatus 13 can again be mounted by way of a mounting arrangement 21.

In contrast to the preceding variants the configuration shown in FIG. 6a however has two heating elements 2. Those heating elements 2 are in the form of induction coils 23 with heating rods 24 (as also already shown in FIG. 2). Integration of the other variants already referred to of the heating elements 2 are also conceivable in respect of this variant of the holding device 1.

FIG. 6b shows an isometric view of FIG. 6a.

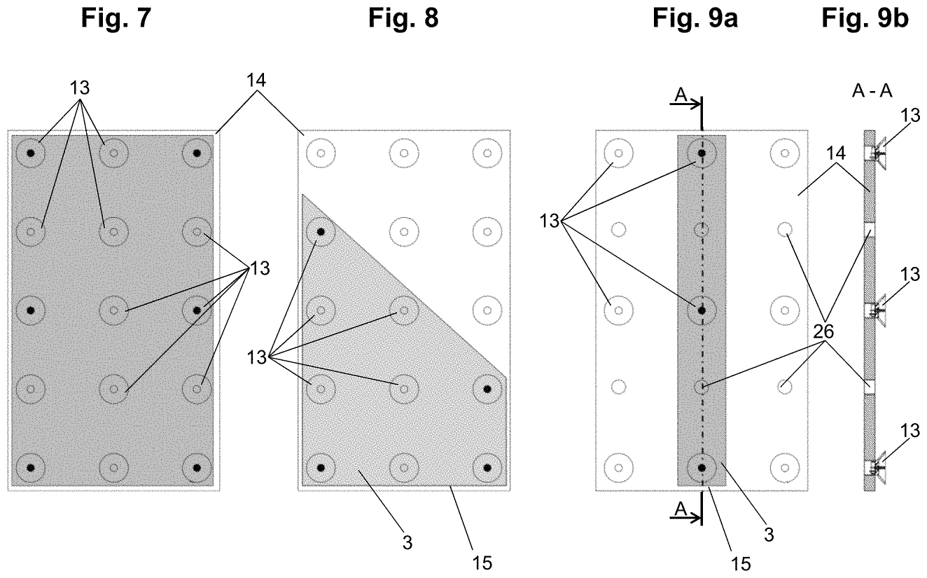

FIG. 7 shows an embodiment according to the invention by way of example comprising a plurality of apparatuses 13. In this case the apparatuses 13 are arranged on a carrier structure 14 which in this embodiment is in the form of plate. Accordingly, at least one flat thermoplastic material 3 can be held at one side in contacting relationship along a surface by a plurality of apparatuses 13. It is not further necessary for each apparatus 13 to have a heating element 2 or each heating element 2 of each apparatus 13 to be used. Thus, with such an arrangement, it can be provided that only selected apparatuses 13 have a heating element 2 or the heating elements 2 of only selected apparatuses 13 are activated. Those selected apparatuses 13 are identified in this Figure by a black dot at the centre thereof.

It can further be provided that an arrangement as shown in FIG. 7 has an open-loop or closed-loop control unit which can selectively actuate individual apparatuses 13 or can actuate a group 15 of apparatuses 13 of all apparatuses 13.

FIG. 8 shows by way of example that only the group 15 of apparatuses 13 is activated by the open-loop or closed-loop control device. In this case the group 15 of apparatuses 13 is identified by grey shading, wherein the grey shading represents a flat thermoplastic material 3 to be handled. By virtue of that selective actuation of a group 15 of apparatuses 13, the apparatuses 13 of the arrangement can be adapted to a geometry of a flat thermoplastic material 3. In this case the open-loop or closed-loop control unit can be so adapted that all holding elements of the holding device 1 of the apparatuses 13 of the group 15 are activated and of that group 15, only some heating elements 2 (for example those at the corners) of the apparatuses 13 are used. In that case once again in FIG. 8 the heating elements 2 in use are identified by black dots at the centre of the apparatuses 13.

It can however also be provided that, in the case of an arrangement as shown in FIGS. 7 and 8, not every receiving device for an apparatus 13 according to the invention (formed by bores 26) is also actually fitted with an apparatus 13 according to the invention, as shown by FIG. 9a. Here too once again a group 15 of apparatuses 13 can be selected. The section A-A indicated in FIG. 9a is shown through FIG. 9b.

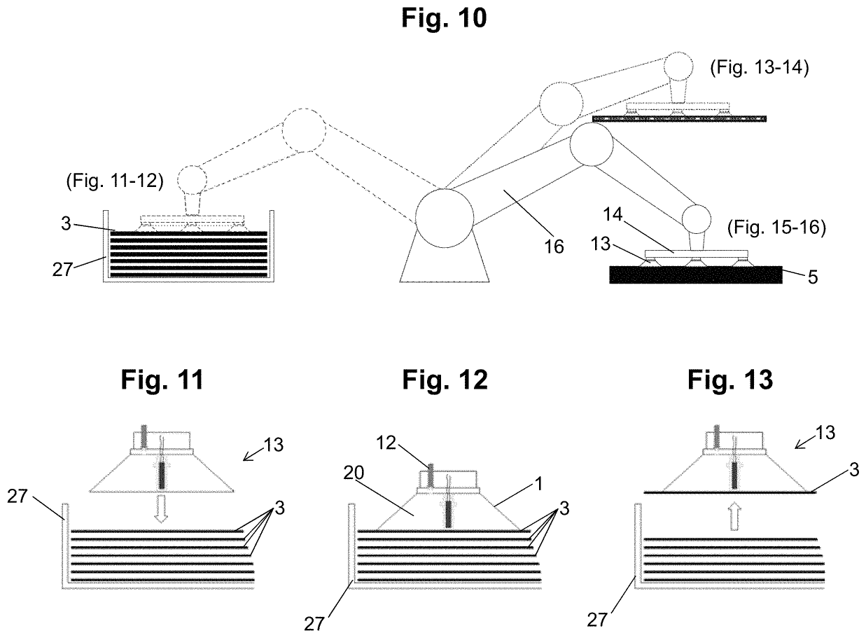

FIG. 10 shows a handling device 16 which by way of a carrier structure 14 has apparatuses 13 with which a flat thermoplastic material 3 can be picked up, transported and deposited on a join partner 5. Those method steps are described in detail hereinafter with reference to FIGS. 11 to 16.

Thus in a first method step as shown in FIG. 11 an apparatus 13 for handling and locally fixing flat thermoplastic materials 3 is brought into contact with a flat thermoplastic material 3 which in this Figure is disposed in a magazine 27.

Subsequently (shown in FIG. 12) a vacuum is built up by way of the suction device 12 in an internal space 20 in the holding device 1 so that the holding device 1 is connected to the flat thermoplastic material 3, more precisely the flat thermoplastic material 3 is held to the holding device 1 by the reduced pressure in the internal space 20.

In a next method step (see FIG. 13) the 4 flat thermoplastic material 3 can be lifted out of the magazine 27 by the apparatus 13.

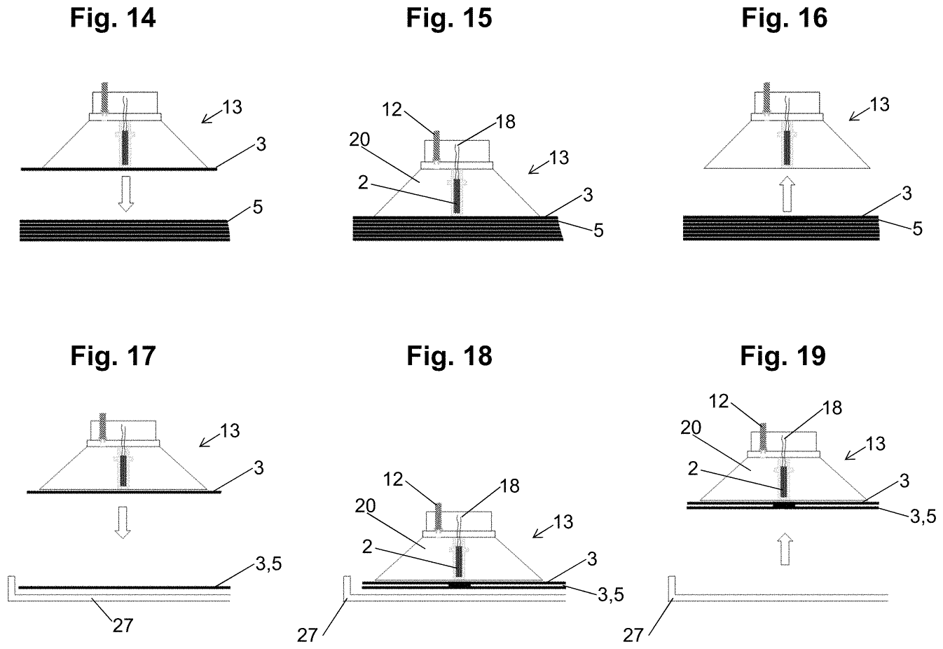

FIG. 14 shows how then the flat thermoplastic material 3 can be brought into contact with a join partner 5 by means of an apparatus 13.

In a following method step (FIG. 15) when the flat thermoplastic material 3 was now brought into contact with a join partner 5 by the apparatus 13 then thermal energy can be introduced into the flat thermoplastic material 3 by means of the heating device 2 so that the flat thermoplastic material 3 is fused on to a join partner 5 and thus locally thermally fixed. In order to prevent unwanted slipping of the flat thermoplastic material 3 during that fixing operation the flat thermoplastic material 3 is further held by the apparatus 13 during that fixing operation insofar as—as shown in this embodiment—a reduced pressure is maintained in an internal space 20. In order to release the flat thermoplastic material 3 from the apparatus 13 after the fixing operation pressure equalisation in respect of the internal space 20 with the environment can be effected by way of the suction device 12 so that a holding force is no longer exerted on the flat thermoplastic material 3 by the apparatus 13. It can also be provided that thermal energy is also already introduced into the flat thermoplastic material 3 prior to contact with the join partner 5, for example during a transport operation or also at the stage when the material is being picked up.

In a last step in the method (shown in FIG. 16) the apparatus 13 is now released from the flat thermoplastic material 3 and the method can begin from the start—for example by repeating the method steps shown in FIGS. 11 to 16.

It is however now also possible by means of an embodiment of the apparatus 13 according to the invention to apply a flat thermoplastic material 3 to a further flat thermoplastic material 3, fuse it, and then lift both flat thermoplastic materials 3, as shown in FIGS. 17 to 19. In that case in a first method step a flat thermoplastic material 3 is moved by the apparatus 13 to a further flat thermoplastic material 3 disposed in a magazine 27, in which case the flat thermoplastic material 3 in the magazine 27 functions in this specific example as the join partner 5. After the held flat thermoplastic material 3 is placed on to the flat thermoplastic material 3 disposed in the magazine 27 thermal energy can be applied to the held flat thermoplastic material 3 by the heating element 2 and thus it can be locally fixed to the flat thermoplastic material 3 in the magazine 27, as shown in FIG. 18.

In a last method step the first flat thermoplastic material 3 can be lifted again by the apparatus 13, now being connected to its join partner 5—the second flat thermoplastic material 3—and thus that can also be lifted out of the magazine 27.

### LIST OF REFERENCES

1 holding device
2 heating element
3 flat thermoplastic material
4 holding region
5 join partner
6 spring element
7 insulating layer
8 electrostatic gripper
9 contact surface
10 vacuum suction gripper
11 suction region
12 suction device
13 apparatus
14 carrier structure
15 group of apparatuses
16 handling device
17 heating cartridge
18 power cable
19 receiving sleeve
20 space
21 mounting arrangement
22 hot gas nozzle
23 induction coil
24 heating rod
25 electrostatic film
26 bore
27 magazine
28 feed passage

1. An apparatus for handling and locally fixing flat thermoplastic materials, comprising at least one holding device which can be applied with a holding region for exerting a holding force against a surface of the flat thermoplastic material, wherein arranged within or surrounded by the holding region of the at least one holding device is at least one heating element by which the flat thermoplastic material can be locally thermally fixed to a join partner within or surrounded by the holding region of the at least one holding device.

2. The apparatus according to claim 1, wherein the flat thermoplastic material can be locally thermally fixed to the join partner in a state held by the at least one holding device.

3. The apparatus according to claim 1, wherein the at least one heating element is connected to the at least one holding device moveably, preferably by a spring element.

4. The apparatus according to claim 1, wherein the flat thermoplastic material is heatable continuously or in interval mode by the at least one heating element.

5. The apparatus according to claim 1, wherein an insulating layer is provided at least region-wise between the at least one heating element and the at least one holding device.

6. The apparatus according to claim 1, wherein the at least one holding device is in the form of an electrostatic gripper, wherein an electrostatic charge of a contact surface of the electrostatic gripper can be applied or changed by at least one activation device.

7. The apparatus according to claim 1, wherein the at least one holding device is in the form of a vacuum suction gripper.

8. The apparatus according to claim 1, wherein the at least one holding element is arranged in a suction region of the vacuum suction gripper.

9. The apparatus according to claim 7, wherein the vacuum suction gripper has a suction device, wherein a reduced pressure can be produced in a suction region of the vacuum suction gripper by the suction device.

10. An arrangement comprising at least two apparatuses for handling and locally fixing flat thermoplastic materials, each of the at least two apparatuses being configured according to claim 1, wherein the at least two apparatuses are connected together by a carrier structure.

11. The arrangement according to claim 10, wherein the at least two apparatuses are so arranged that at least one flat thermoplastic material can be held at one side in unilateral contacting relationship along a surface by the at least two holding devices.

12. The arrangement according to claim 10, wherein there is provided an open-loop or closed-loop control unit, wherein each apparatus or when there are more than two apparatuses a group of apparatuses can be selectively open-loop or closed-loop controlled by the open-loop or closed-loop control unit, wherein at least one holding device can be selectively open-loop or closed-loop controlled and/or at least one heating element can be selectively open-loop or closed-loop controlled by the open-loop or closed-loop control unit.

13. A handling device for picking up, transporting, and/or depositing at least one flat thermoplastic material, the handling device comprising the apparatus according to claim 1.

14. A handling device for picking up, transporting, and/or depositing at least one flat thermoplastic material, the handling device comprising the arrangement according to claim 10.
